(19) United States
(12) Patent Application Publication
(10) Pub. No.: US 2009/0116896 A1
(43) Pub. Date: May 7, 2009

(54) Ring Binder Mechanism with Pen Holder

(75) Inventor: Chun Yuen To, Hong Kong (CN)

Correspondence Address: SENNIGER POWERS LLP, 100 NORTH BROADWAY, 17TH FLOOR, ST LOUIS, MO, 63102, US

(73) Assignee: WORLD WIDE STATIONERY MFG. CO., LTD., Hong Kong (CN)

(21) Appl. No.: 11/936,356

(22) Filed: Nov. 7, 2007

(51) Int. Cl. B42F 13/20

(52) U.S. Cl. 402/36; 402/4

(57) ABSTRACT

A ring binder mechanism, including a holder assembly adapted for releasably securing a writing implement to the ring binder mechanism. The holder assembly includes a holder and a bracket. The holder is sized and shaped to hold objects such as writing implements (e.g., pens and pencils). The bracket uses tabs for insertion into holes in a housing of the ring binder to mount the holder to the ring binder mechanism.

### FIELD OF THE INVENTION

The present invention generally relates to ring binder mechanism for retaining loose-leaf pages, and in particular to a ring binder mechanism having a holder mounted thereon for holding objects in the ring binder mechanism.

### BACKGROUND OF THE INVENTION

Conventional notebooks include a cover and a ring binder mechanism mounted on the cover for retaining loose-leaf pages. Ring members of the ring binder mechanism can be selectively opened to add or remove pages or closed to retain pages while allowing the pages to be moved along the ring members. While conventional notebooks are well suited for holding loose-leaf pages, they are typically not suited for holding implements (e.g., pens or pencils) for writing on the loose-leaf pages. In instances where they do hold pens, pencils, and the like, the location can be inconvenient and the notebook incapable of holding implements having a range of diameters.

### SUMMARY OF THE INVENTION

In one aspect of the present invention, a ring binder mechanism for holding loose-leaf pages generally comprises a housing, a ring mount supported by the housing for movement relative to the housing, and rings for holding the loose-leaf pages. Each ring includes a first ring member and a second ring member. The first ring member is operatively connected to the ring mount for movement relative to the second ring member between a closed position and an opened position of the ring members. In the closed position, the two ring members form a substantially continuous, closed loop for allowing loose-leaf pages retained by the rings to be moved along the rings from one ring member to the other. In the opened position, the two ring members form a discontinuous, open loop for adding or removing loose-leaf pages from the rings. A holder is mounted on the housing and is adapted to releasably hold an object.

In another aspect of the present invention, a ring binder mechanism for holding loose-leaf pages generally comprises a housing with slots, a ring mount supported by the housing for movement relative to the housing, and rings for holding the loose-leaf pages. Each ring includes a first ring member and a second ring member.

The first ring member is operatively connected to the ring mount for movement relative to the second ring member between a closed position and an opened position of the ring members. In the closed position, the two ring members form a substantially continuous, closed loop for allowing loose-leaf pages retained by the rings to be moved along the rings from one ring member to the other. In the opened position, the two ring members form a discontinuous, open loop for adding or removing loose-leaf pages from the rings. A holder assembly is mounted on the housing and is adapted to releasably hold an object. The holder assembly includes an accordion folded member resiliently moveable between a more folded and an expanded more unfolded condition. The holder assembly also includes a bracket with tabs received in the slots of the housing and bent around the housing for securing the accordion folded member to the housing.

Other objects and features will be in part apparent and in part pointed out hereinafter.

### BRIEF DESCRIPTION OF THE DRAWINGS

FIG. 1 is a fragmentary perspective of a notebook for holding loose-leaf pages, illustrating a pen being held by a holder on a ring binder mechanism;

FIG. 2 is a topside perspective of the ring binder mechanism with rings of the mechanism being in a closed position;

FIG. 3 is the perspective of FIG. 2 with the holder and bracket exploded from the ring binder mechanism;

FIG. 4 is a bottom side perspective of the ring binder mechanism;

FIG. 5 is a section taken in the plane including line 5-5 of FIG. 2;

FIG. 6 is a topside perspective of the ring binder mechanism with the rings in an open position;

FIG. 7 is a bottom side perspective of the ring binder mechanism of FIG. 6;

FIG. 8 is a perspective of the holder;

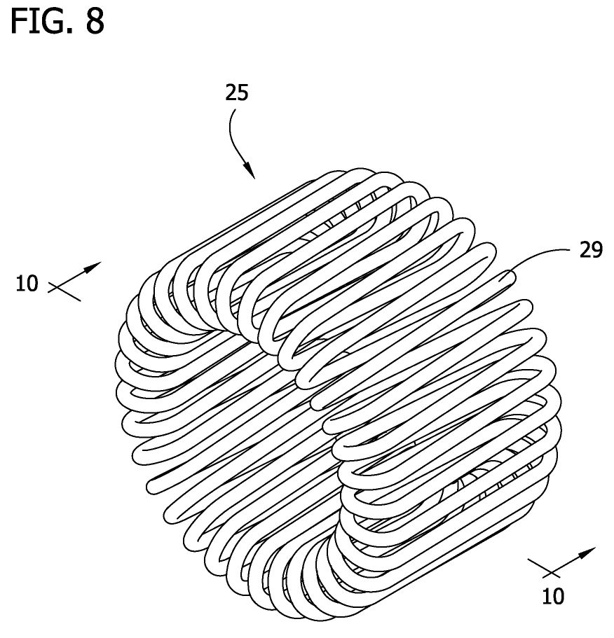

FIG. 9 is a front elevation of the holder;

FIG. 10 is a cross section of the holder;

FIG. 11 is an exploded view of the ring binder mechanism; and

FIG. 12 is a section of a housing of the ring binder mechanism taken in the plane including line 12-12 in FIG. 11.

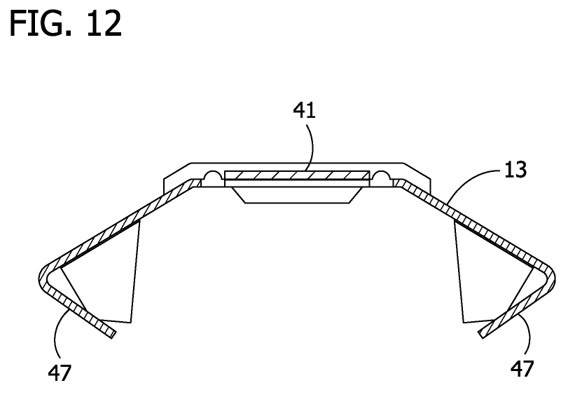

Corresponding reference characters indicate corresponding parts throughout the drawings.

### DETAILED DESCRIPTION

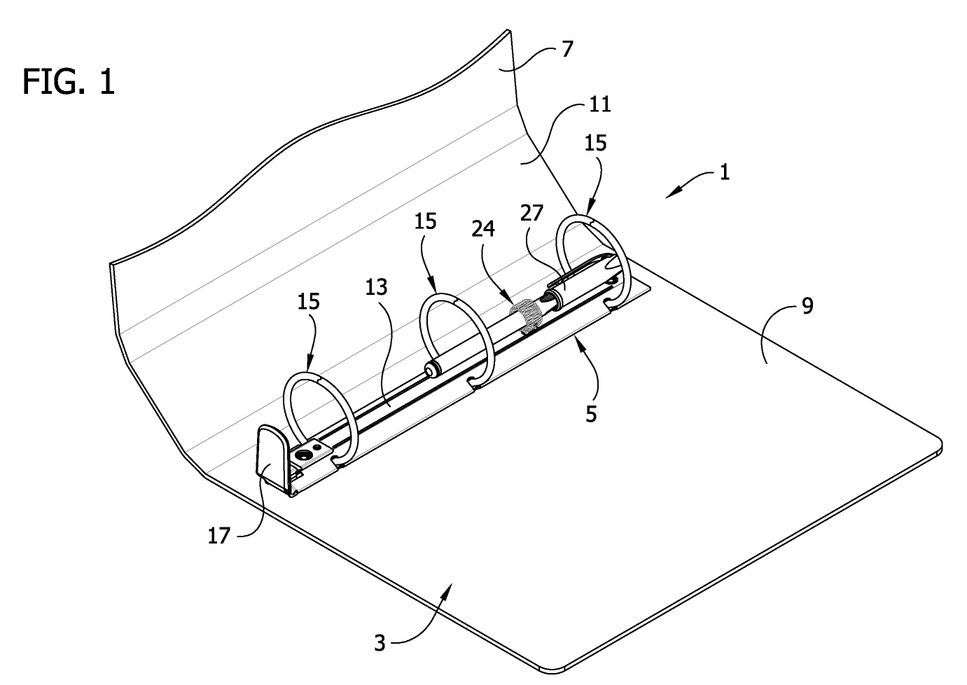

Referring now to the drawings, FIG. 1 illustrates a notebook, indicated generally at 1, comprising a cover, designated generally at 3, and a ring binder mechanism, designated generally at 5, mounted on the cover. The cover 3 includes a front 7, a back 9, and a spine 11. The front 7 and back 9 are hingedly attached to the spine 11. The ring binder mechanism 5 comprises a housing 13, three rings (each designated generally at 15) supported by the housing, and a lever 17 (also broadly referred to as an “actuator”) mounted adjacent an end of the housing. The rings 15 retain loose-leaf pages (not shown) on the ring binder mechanism 5 in the notebook 1 while the lever 17 operates to open and close the rings so that pages can be added or removed. The front 7 of the cover 3 moves relative to the ring binder mechanism 5 to selectively cover or expose loose-leaf pages retained by the ring binder mechanism in the notebook 1. Ring binder mechanisms mounted on notebooks in other ways or on surfaces other than a notebook, for example, a file; do not depart from the scope of this invention. Moreover, a notebook may have other configurations than the one shown and described herein without departing from the scope of the present invention.

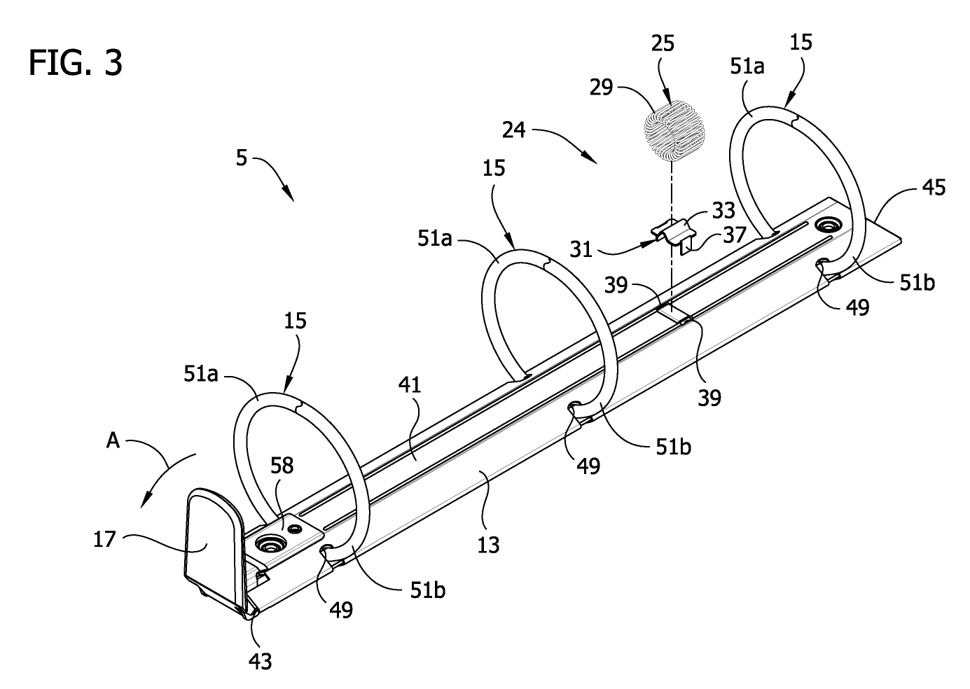

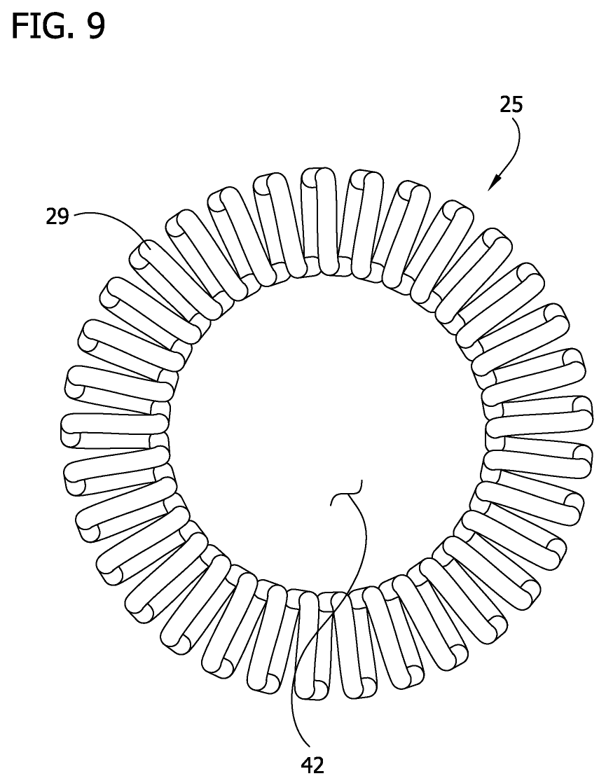

The ring binder mechanism 5 further comprises a holder assembly, designated generally at 24, mounted on the housing 13 and adapted to hold an object. The holder assembly 24 comprises a holder 25 and a bracket 31 (FIG. 3). The holder 25 is sized and shaped for releasably holding a writing implement (e.g., a pencil or a pen 27 as is illustrated in FIG. 1) or other object. The holder 25 is expandable for holding writing implements of different sizes. In the illustrated configuration, the holder 25 is adapted for holding writing implements (e.g., pen 27) with cross-sectional diameters between about 6.5 mm and about 16 mm. More specifically, the holder 25, which is generally cylindrical, comprises an accordion folded wire 29 that is resiliently expandable in diameter between a more folded condition (FIG. 9) and an expanded, more unfolded condition for holding the writing implements (e.g., as in FIG. 1). The resiliency of the holder 25 allows it to bear against and grip the pen 27 when held by the holder. The size and shape of the holder 25 also allows the holder to be contained within the dimensions of the ring binder 5, permitting the use of the ring binder (i.e. inserting, removing and turning loose-leaf pages) without interference by the holder or the object being held by the holder.

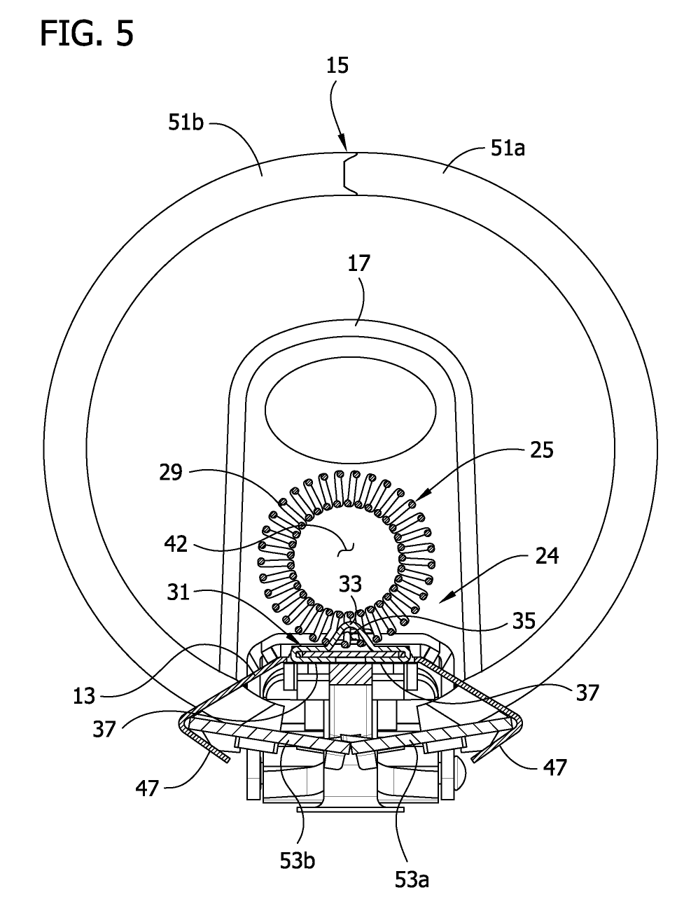

The bracket 31 is mounted on the housing 13 for securing the folded wire 29 to the housing 13. With reference to FIGS. 3 and 5, the bracket 31 includes a peak 33 defining a channel 35 for capturing several longitudinal segments or folds of the folded wire 29 (FIG. 5). Two tabs 37 (only one is shown) are provided on the bracket 31 for insertion into slots 39 on the housing 13 to mount the bracket 31 to the housing 13. After insertion, the tabs 37 are bent inward toward the center of the housing 13 and rest against the underside of a generally flat plateau 41 of the housing, forming a secure engagement between the bracket 31 and the housing. In the illustrated configuration, the holder is seen mounted generally toward one end of the housing but it is understood that the holder can be mounted in different location on the housing. It is also understood that more than one holder can be mounted on the housing so that more then one writing implement can be held on the ring binder.

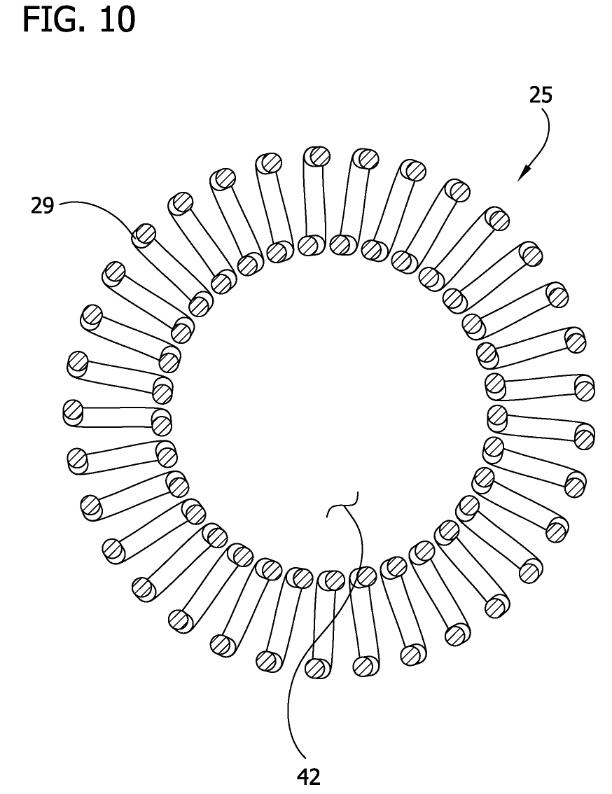

The holder assembly 24 is used by inserting a writing implement or other object through a passage 42 in the holder 25 (See FIGS. 9 and 10). The elastic nature of the folded wire 29 will cause the holder 25 to radially expand as the object is inserted and the resiliency of the folded wire will allow it to bear against and grip the object providing a secure hold on the object. To remove the object from the holder 25 the object is slid out of engagement with the folded wire 29 by pushing or pulling on the object until it is no longer captured by the wire. Other, non-resilient constructions of a holder may be used within the scope of the present invention. Moreover, a resilient holder may be formed out of other than folded wire.

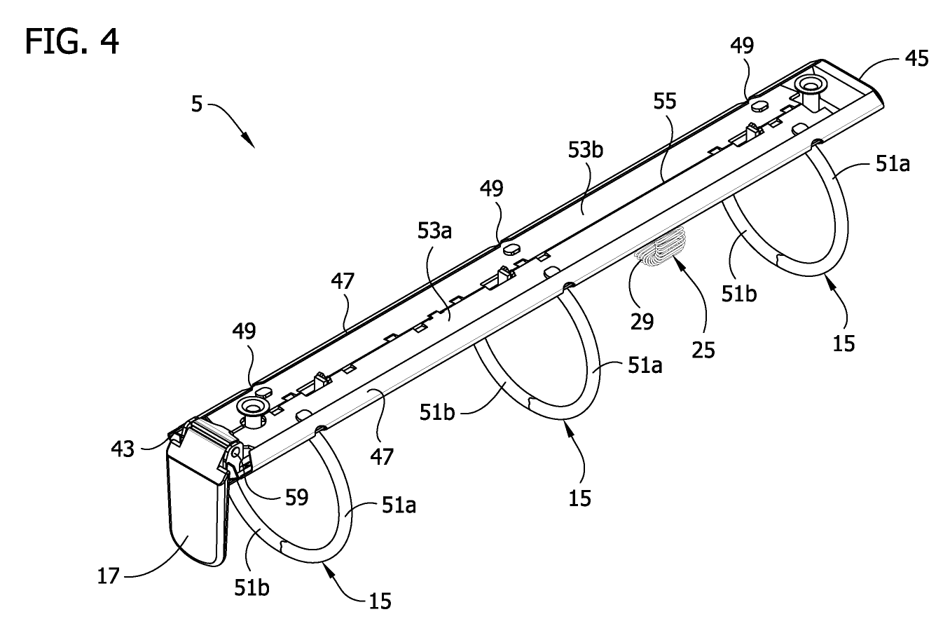

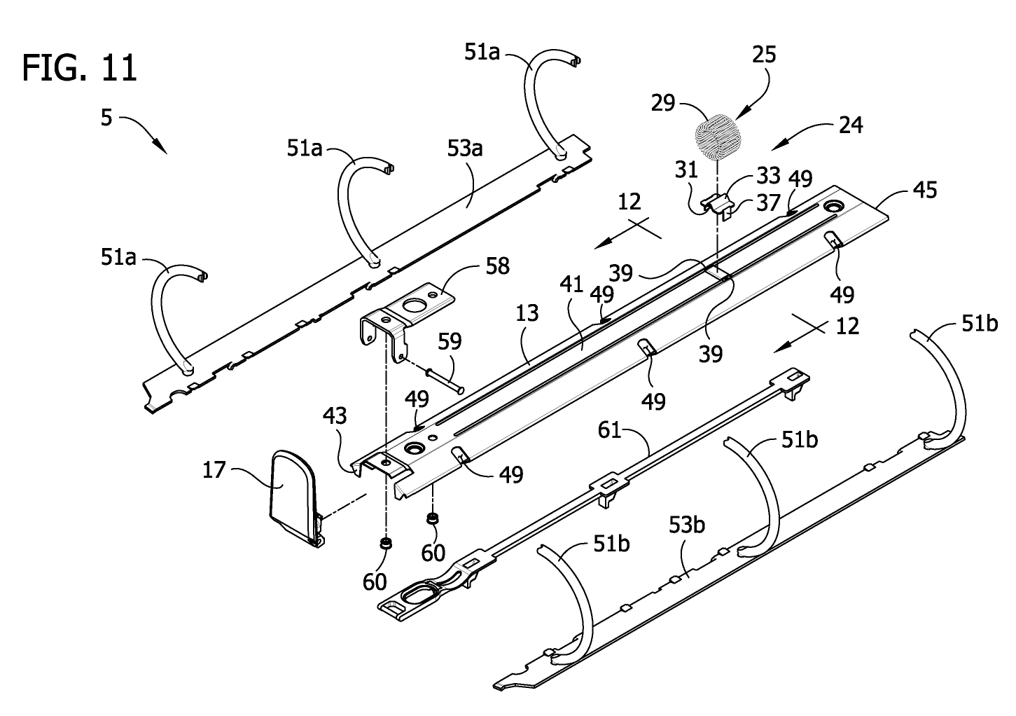

The housing 13 of the ring binder mechanism 5 is shaped as an elongate rectangle with a uniform, roughly arch-shaped cross section, having at its center the generally flat plateau 41. A first longitudinal end 43 of the housing 13 (to the left in FIG. 11) is generally open while a second, opposite longitudinal end 45 is generally closed (to the right in FIG. 11). As seen in FIGS. 4 and 5, bent under rims 47 extend lengthwise along longitudinal edges of the housing 13 from its first longitudinal end 43 to its second longitudinal end 45. Each of the bent under rims 47 includes three spaced-apart cutouts 49. Mechanisms having housings of other shapes, including irregular shapes, or housings that are integral with a file or notebook do not depart from the scope of this invention.

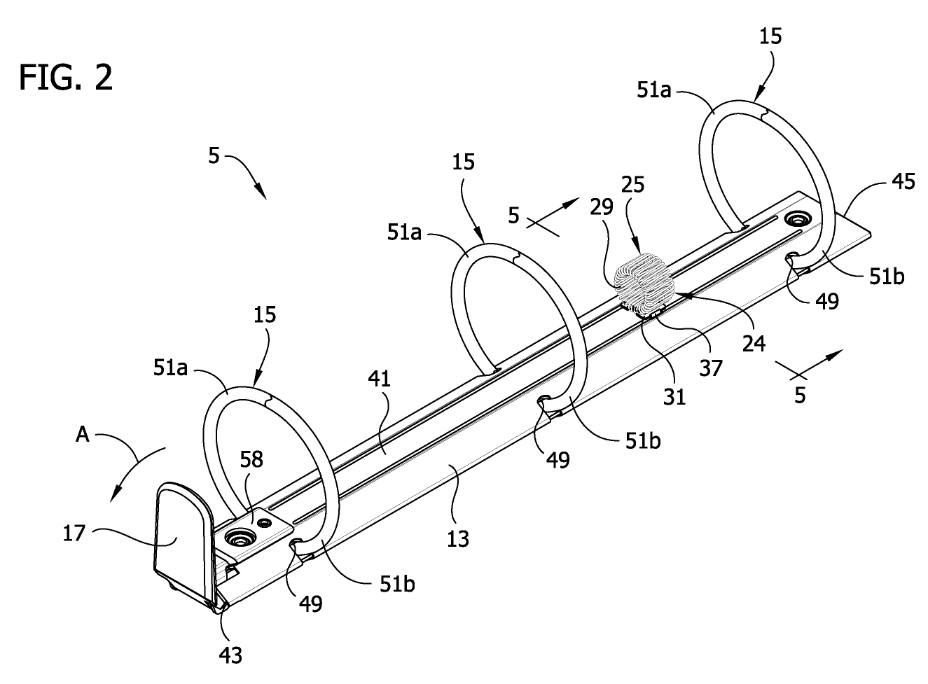

The three rings 15 of the ring binder mechanism 5 are substantially similar and are each generally circular in shape (e.g., FIG. 2). Each of the rings has two generally semi-circular ring members 51a, 51b formed from a conventional, cylindrical rod of a suitable material (e.g., steel). The rings 15 could be D-shaped as is known in the art, or otherwise shaped within the scope of this invention. Ring binder mechanisms with ring members formed of different material or having different cross-sectional shapes, for example, oval shapes, or different free end configurations do not depart from the scope of this invention.

As illustrated in FIGS. 4, 7 and 11, the ring binder mechanism 5 includes two substantially identical hinge plates (together broadly defining a “ring mount”), designated generally at 53a, 53b, supporting the ring members 51a, 51b, respectively. The hinge plates 53a, 53b are each generally elongate, flat, and rectangular in shape and are each somewhat shorter in length than the housing 13. The hinge plates 53a, 53b are interconnected in parallel arrangement along their inner longitudinal edge margins, forming a central hinge 55 having a pivot axis. This is done in a conventional manner known in the art. As will be described, the hinge plates 53a, 53b can pivot about the central hinge 55 upward and downward.

The housing 13 supports the interconnected hinge plates 53a, 53b within the housing. The outer longitudinal edge margins of the hinge plates 53a, 53b loosely fit behind the bent under rims 47 of the housing 13 for allowing them to move within the rims when the hinge plates pivot. The ring members 51a, 51b extend through respective cutouts 49 along sides of the housing 13 so that the ring members can engage above the housing. The ring members 51a, 51b are rigidly connected to respective ones of the hinge plates 53a, 53b as is known in the art and move with the hinge plates when they pivot. Although in the illustrated ring binder mechanism 5 both ring members 51a, 51b of each ring 15 are each mounted on one of the two hinge plates 53a, 53b and move with the pivoting movement of the hinge plates, a mechanism in which each ring has one movable ring member and one fixed ring member does not depart from the scope of this invention (e.g., a mechanism in which only one of the ring members of each ring is mounted on a hinge plate with the other ring member mounted, for example, on a housing).

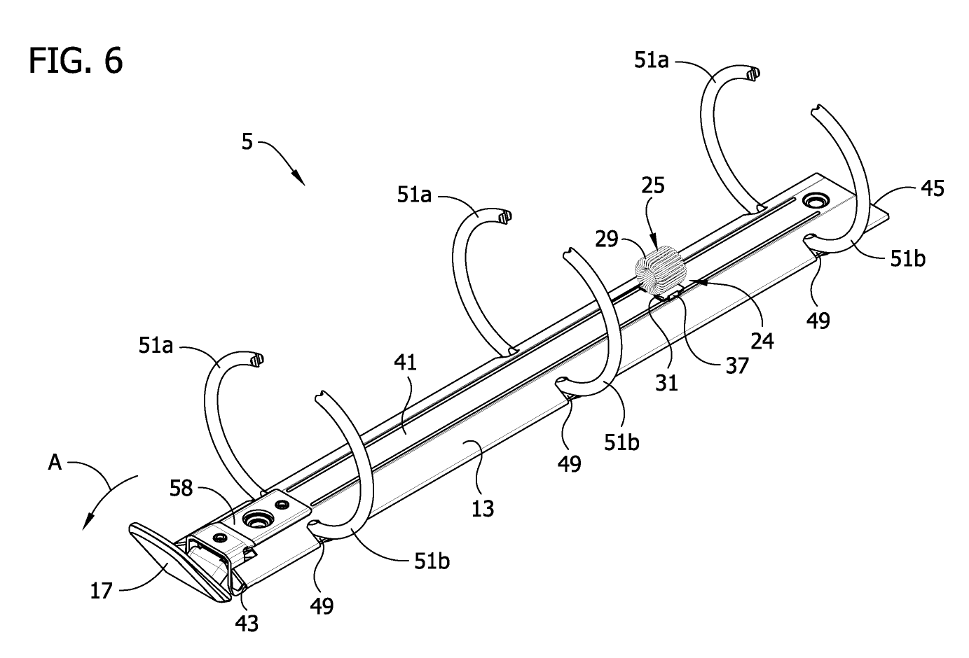

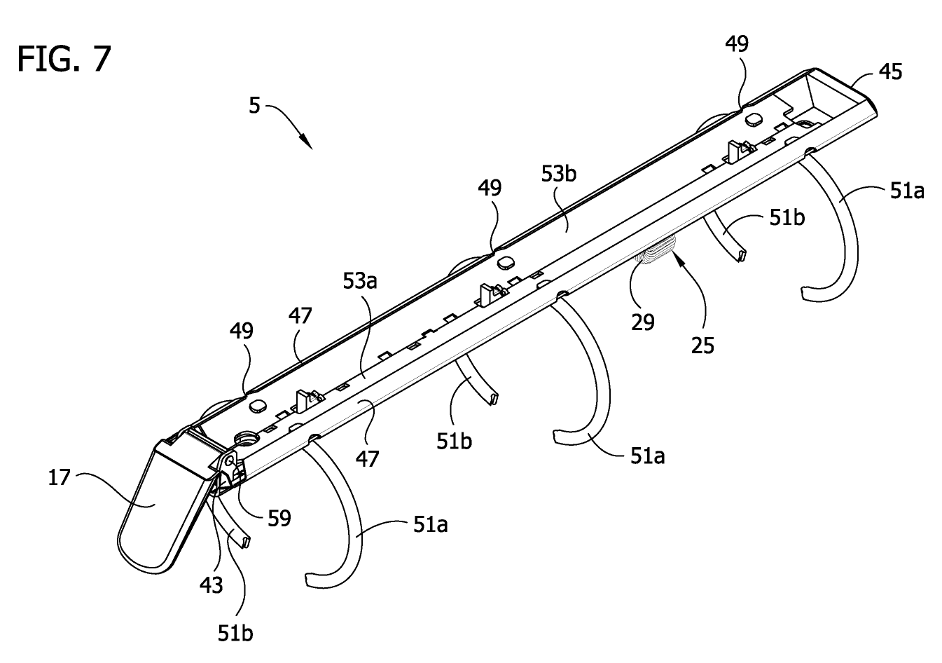

As is known, the hinge plates 53a, 53b pivot downward and upward relative to the housing 13 and move the ring members 51a, 51b mounted thereon between a closed position (FIG. 2) and an opened position (FIG. 6). The hinge plates 53a, 53b are wider than the housing 13 when in a co-planar position (180°), so as they pivot through the co-planar position, they deform the housing and create a spring force in the housing. The housing spring force biases the hinge plates 53a, 53b to pivot away from the co-planar position, either downward or upward. The ring members 51a, 51b close when the hinge plates 53a, 53b pivot downward (i.e., the central hinge 55 moves away from the housing 13 (FIG. 7)). The ring members 51a, 51b open when the hinge plates 53a, 53b pivot upward (i.e., the central hinge 55 moves toward the housing 13 (FIG. 6)).

The lever 17 is pivotally mounted on the housing 13 adjacent the first longitudinal end 43 thereof, suitably with a lever mount 58 and a hinge pin 59 (see, FIGS. 7 and 11). Rivets 60 fixedly secure the lever mount 58 to the housing 13, adjacent the hinge plates 53a, 53b, such that pivoting movement of the lever 17 is translated to the hinge plates. Pivoting movement of the lever 17 in a counter-clockwise direction as indicated by the arrow A in FIG. 2 causes the lever to contact and conjointly pivot the interconnected hinge plates 53a, 53b upward. Once the hinge plates 53a, 53b pass through the co-planar position, the housing spring force pushes them upward, opening the ring members 51a, 51b. To close the ring members 51a, 51b, an operator can pivot the lever 17 from the position illustrated in FIG. 6 upward and inward (i.e., clockwise in FIG. 6) back to the position illustrated in FIG. 2. During pivoting of the lever 17, the lever contacts and pushes downward on the upper surfaces of the hinge plates 53a, 53b, but the spring force of the housing 13 resists the initial hinge plate movement. As the lever 17 continues to pivot, the lever 17 causes the interconnected hinge plates 53a, 53b to pivot downward. Once the hinge plates 53a, 53b pass through the co-planar position, the housing 13 spring force pushes them downward, closing the ring members 51a, 51b. In the illustrated configuration, the ring members 51a, 51b can also be closed by manually pushing the ring members together. An actuator (not shown) may take other forms than the lever 17. Further, there may be more than one lever. The lever 17 is also connected to a travel bar 61 that can move when actuated by the lever generally lengthwise within the housing 13. The travel bar 61 is used for locking the hinge plates 53a, 53b in the closed position to prevent the rings 51a, 51b from being inadvertently opened.

Mounting posts (not shown) are secured to the illustrated ring binder mechanism 5 to mount the mechanism on the cover 3 in any suitable manner. The posts are attached to the plateau 41 of the housing 13 toward the longitudinal ends 43, 45 of the housing. It is understood that the ring binder mechanism can be secured to the cover in different ways.

Components of ring binder mechanisms of the embodiments described and illustrated herein are made of a suitable rigid material, such as a metal (e.g. steel). But mechanisms having components made of a nonmetallic material, specifically including a plastic, do not depart from the scope of this invention.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

What is claimed is:

1. A ring binder mechanism for holding loose-leaf pages, the ring binder mechanism comprising:
a housing;
a ring mount supported by the housing for movement relative to the housing;
rings for holding the loose-leaf pages, each ring including a first ring member and a second ring member, the first ring member being operatively connected to the ring mount for movement relative to the second ring member between a closed position and an opened position of said ring members, in the closed position the two ring members forming a substantially continuous, closed loop for allowing loose-leaf pages retained by the rings to be moved along the rings from one ring member to the other, and in the opened position the two ring members forming a discontinuous, open loop for adding or removing loose-leaf pages from the rings; and
a holder mounted on the housing and adapted to releasably hold an object.

2. The ring binder mechanism as set forth in claim 1 wherein the holder is expandable for holding objects of different sizes.

3. The ring binder mechanism as set forth in claim 2 wherein the holder is sized and shaped for holding a writing implement.

4. The ring binder mechanism as set forth in claim 3 in combination with a writing implement.

5. The combination as set forth in claim 4 wherein the writing implement has a cross-sectional diameter between about 6.5 mm and about 16 mm.

6. The combination as set forth in claim 5 wherein the writing implement is selected from a group consisting of a pen, a pencil and a marker.

7. The ring binder mechanism as set forth in claim 3 wherein the holder comprises an accordion folded member that is resiliently moveable between a more folded condition and an expanded, more unfolded condition.

8. The ring binder mechanism as set forth in claim 7 wherein the holder further comprises a bracket mounted on the housing for securing the accordion folded member to the housing.

9. The ring binder mechanism as set forth in claim 8 wherein the housing has slots therein, portions of the bracket being received in the slots for mounting the bracket on the housing.

10. The ring binder mechanism as set forth in claim 9 wherein the bracket comprises tabs received in the slots for mounting the holder to the ring binder mechanism.

11. The ring binder mechanism as set forth in claim 9 wherein the bracket captures at least one fold of the accordion folded member thereby securing the member to the housing.

12. The ring binder mechanism as set forth in claim 1 in combination with a cover having a front, a back, and a spine, the front and back being hingedly attached to the spine for movement to selectively cover and expose the loose-leaf pages, the ring binder mechanism being mounted on the cover.

13. A ring binder mechanism for holding loose-leaf pages, the ring binder mechanism comprising:
a housing having slots therein;
a ring mount supported by the housing for movement relative to the housing;
rings for holding the loose-leaf pages, each ring including a first ring member and a second ring member, the first ring member being operatively connected to the ring mount for movement relative to the second ring member between a closed position and an opened position of said ring members, in the closed position the two ring members forming a substantially continuous, closed loop for allowing loose-leaf pages retained by the rings to be moved along the rings from one ring member to the other, and in the opened position the two ring members forming a discontinuous, open loop for adding or removing loose-leaf pages from the rings; and
a holder assembly mounted on the housing and adapted to releasably hold an object, the holder assembly comprising an accordion folded member that is resiliently moveable between a more folded condition and an expanded, more unfolded condition and a bracket comprising tabs received in the slots in the housing and bent around the housing for securing the accordion folded member to the housing.
